(19) United States
(12) Patent Application Publication
(10) Pub. No.: US 2009/0038512 A1
(43) Pub. Date: Feb. 12, 2009

(54) CRYSTALLINE COLLOIDAL ARRAYS WITH INORGANIC SOL-GEL MATRIX

(75) Inventors: Xiangling Xu, Pittsburgh, PA (US); Shan Cheng, Sewickley, PA (US); Sean Purdy, Cincinnati, OH (US); Noel R. Vanier, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/835,440

(22) Filed: Aug. 8, 2007

(51) Int. Cl. C01B 33/00; B01J 13/00; C08G 77/04; C08J 9/00; C08J 9/26; C09D 7/00

(52) U.S. Cl. 106/287.35; 252/600; 516/111; 516/98; 521/154; 521/63; 523/218

(57) ABSTRACT

A radiation diffractive material that diffracts radiation according to Bragg's law is disclosed. The material includes an ordered periodic array of diffracting regions received within a matrix, the matrix comprising an inorganic sol-gel.

### FIELD OF THE INVENTION

This invention relates to radiation diffractive materials, more particularly to colloidal arrays of particles held in an inorganic sol-gel matrix.

### BACKGROUND OF THE INVENTION

Radiation diffractive materials based on crystalline colloidal arrays have been used for a variety of purposes. A crystalline colloidal array (CCA) is a three-dimensional ordered array of mono-dispersed colloidal particles. The particles are typically composed of a polymer latex, such as polystyrene or an inorganic material, such as silica. These colloidal dispersions of particles can form crystalline structures having lattice spacings that are comparable to the wavelengths of ultraviolet, visible or infrared radiation. The crystalline structures having been used for filtering narrow bands of selective wavelengths from a broad spectrum of incident radiation, while permitting the transmission of adjacent wavelengths of light. Alternatively, CCAs are fabricated to diffract radiation for use as colorants, markers, optical switches, optical limiters and sensors.

Many of these devices have been produced by dispersing particles in a liquid medium, whereby the particles self-align into an ordered array. The particles are fused together by mutual polymerization or by introduction of a solvent that swells and fuses the particles together.

Other CCAs are produced from a dispersion of similarly charged mono-dispersed particles in a carrier. The dispersion is applied to a substrate, and the carrier is evaporated to yield an ordered periodic array of particles. The array is fixed in place by coating the array with a curable polymer, such as an acrylic polymer, polyurethane, alkyd polymer, polyester, siloxane-containing polymer, polysulfide or epoxy-containing polymer. Methods for producing such CCAs are disclosed in U.S. Pat. No. 6,894,086, incorporated herein by reference.

Radiation diffractive materials based on CCAs diffract radiation according to Bragg's law and satisfy the equation:

mλ=2ndsin θ

where m is an integer, λ is the wavelength of reflected radiation, and n is the effective refractive index of the array, d is a distance between layers of the particles and θ is the angle that the reflected radiation makes with the plane of the first layer of the particles. Incident radiation is partly reflected at uppermost layers of particles in the array at angle θ to the plane of the first layer and is partially transmitted to underlying layers of the particles. Some absorption of incident radiation occurs as well, and a portion of the transmitted radiation is partially reflected at the second layer of particles in the array angle θ and partially transmitted to the underlying layers of particles. This feature of partial reflection at angle θ and partial transmission to the underlying layers of particles continues through the thickness of the array. The wavelength (λ) of diffracted radiation can be controlled by the dimension (d), which is generally the distance between the planes of the centers of the particles in each layer. As such, the diffractive wavelength (λ) is proportional to the particle diameter (d) for an array of packed particles. Thus, the inter-particle distance is an important factor for producing CCAs that diffract radiation according to a particular wavelength (λ).

A drawback to conventional CCAs is the propensity of the matrices surrounding the particles (such as acrylic polymers or hydrogel-based matrices) to swell upon exposure to water or organic solvents or the like. Swelling of the matrix can cause the inter-particle distance (d) to increase and the wavelength of radiation diffracted by the CCA to change. In instances where a stable wavelength of diffracted radiation is required, such as in producing a particular color or activating an optical switch, the propensity of a matrix in a CCA to swell upon exposure to solvents is problematic.

### SUMMARY OF THE INVENTION

The present invention is directed to a radiation diffraction material comprising an ordered periodic array of diffracting regions received within a matrix, the matrix comprising an inorganic sol-gel. The present invention also includes a method of producing a radiation diffractive material comprising providing an ordered periodic array of particles, coating the array of particles with an inorganic sol and polymerizing the sol to yield a sol-gel. Also included in the present invention is a packaging for receiving an article, the packaging bearing a radiation diffraction material, said radiation diffraction material comprising an ordered periodic array of diffracting regions received within a matrix, said matrix comprising an inorganic sol-gel

### DETAILED DESCRIPTION OF THE INVENTION

The present invention includes radiation diffractive material, where the material diffracts radiation in the visible and/or non-visible spectrum and methods for making the same. The radiation diffractive material includes an ordered periodic array of diffracting regions received in a polymeric matrix. By diffracting regions it is meant regions having a refractive index that differs from the refractive index of the surrounding matrix, including but not limited to discrete particles and/or voids in the matrix, the voids containing ambient air or other filler composition. Radiation diffractive material of the present invention having voids (empty or receiving another composition) can be produced by first preparing radiation diffractive material with particles and subsequently removing the particles as discussed below.

Thus, either the final product or an intermediate product of the present invention utilizes an ordered periodic array of particles. The array includes a plurality of layers of the diffracting regions and satisfies Bragg's law of:

mλ=2ndsin θ

where m is an integer, n is the effective refractive index of the array, d is the distance between the layers of diffracting regions, and λ is the wavelength of radiation reflected from the plane a layer of the diffracting regions at angle θ. As used herein, “a” wavelength of diffracted radiation includes a band of the electromagnetic radiation spectrum. For example, reference to a wavelength of 600 nm may include 595 to 605 nm. The reflected radiation may be in the visible spectrum or invisible spectrum (infrared or ultraviolet radiation). The material may diffract radiation in both the visible and infrared spectra, or it may diffract in both the visible and ultraviolet spectra.

### Particles

Various compositions may be used for the particles, including, but not limited to, organic polymers such as polystyrene, polyurethane, acrylic polymers, alkyd polymers, polyesters, siloxane-containing polymers, polysulfides, epoxy-containing polymers and inorganic materials such as metal oxides (e.g., alumina, silica, zinc oxide, or titanium dioxide) or semi-conductors such as cadmium. Alternatively, the particles may have a core-shell structure where the core can be produced from the same materials as the above-described unitary particles. The shell may be produced from the same polymers as the core material, with the polymer of the particle shell differing from the core material for a particular array of the core-shell particles. The core material and the shell material can have different indices of refraction. In addition, the refractive index of the shell may vary as a function of the shell thickness in the form of a gradient of refractive index through the shell thickness. The shell material is non-film-forming, whereby the shell material remains in position surrounding each particle core without forming a film of the shell material so that the core-shell particles remain as discrete particles within the polymeric matrix.

Typically, the particles are generally spherical. For core-shell particles, the diameter of the core may constitute 85 to 95% of the total particle diameter or 90% of the total particle diameter with the shell constituting the balance of the particle diameter and having a radial thickness dimension.

In one embodiment, the particles with a unitary structure (not core-shell) are produced via emulsion polymerization in the presence of a surfactant, yielding a dispersion of charged particles. Suitable surfactants for dispersion of latex particles include, but are not limited to, sodium styrene sulfonate, sodium 1-allyloxy-2- hydroxypropyl sulfonate (commercially available as Sipomer COPS-I from Rhodia Corporation), acrylamide propyl sulfonate, and sodium allyl sulfonate. Particularly useful surfactants are those that are minimally soluble in the dispersing fluid (e.g., water) of the particle dispersion. The charged particles are purified from the dispersion by techniques such as ultra-filtration, dialysis or ion-exchange to remove undesired materials, such as un-reacted monomer, small polymers, water, initiator, surfactant, unbound salt and grit (agglomerated particles) to produce a monodispersion of charged particles. Ultra-filtration is particularly suitable for purifying charged particles. When the particles are in dispersion with other materials, such as salts or by-products, the repelling forces of the charged particles can be mitigated; therefore, the particle dispersion is purified to essentially contain only the charged particles, which then readily repel each other and form an ordered array.

In another embodiment of the invention, core-shell particles are produced by dispersing core monomers with initiators in solution to produce core particles. Shell monomers are added to the core particle dispersion, along with an emulsifier and/or surfactant (as described above for unitary particles), such that the shell monomers polymerize onto the core particles. A dispersion of the core-shell particles is purified as described above to produce a dispersion of only the charged core-shell particles, which then form an ordered array on a substrate as described below.

### Array of Particles

Upon removal of the excess raw material, by-products, solvent and the like, electrostatic repulsion of the charged particles causes the particles to align themselves into an ordered array. The purified dispersion of particles is applied to a substrate and dried. The dispersion of particles applied to the substrate may contain 10-70 vol. % of charged particles or 30-65 vol. % of charged particles. The dispersion can be applied to the substrate by dipping, spraying, brushing, roll-coating, curtain coating, flow-coating or die-coating to a desired thickness. The wet coating may have a thickness of 4-50 microns, such as 40 microns. Upon drying, the material contains essentially only the particles that have self-aligned in a Bragg array and diffract radiation accordingly.

The substrate may be a flexible material, such as metal sheet or foil (e.g. aluminum foil), paper or a film (or sheet) of polyester or polyethylene terephthalate (PET), or an inflexible material, such as glass or plastic. By “flexible” it is meant that the substrate can undergo mechanical stresses, such as bending, stretching, compression and the like, without significant irreversible change. One suitable substrate is a microporous sheet. Some examples of microporous sheets are disclosed in U.S. Pat. Nos. 4,833,172; 4,861,644 and 6,114,023, which are incorporated herein by reference. Commercially available microporous sheets are sold under the designation Teslin® by PPG Industries, Inc. Other suitable flexible substrates include natural leather, synthetic leather, finished natural leather, finished synthetic leather, suede, vinyl nylon, ethylene vinyl acetate foam (EVA form), thermoplastic urethane (TPU), fluid-filled bladders, polyolefins and polyolefin blends, polyvinyl acetate and copolymers, polyvinyl chloride and copolymers, urethane elastomers, synthetic textiles and natural textiles.

In certain embodiments, the flexible substrates are compressible substrates. “Compressible substrate” and like terms refer to substrates capable of undergoing a compressive deformation and returning to substantially the same shape once the compressive deformation has ceased. The term “compressive deformation” means a mechanical stress that reduces the volume at least temporarily of a substrate in at least one direction.

“EVA foam” can comprise open cell foam and/or closed cell foam. “Open cell foam” means that the foam comprises a plurality of interconnected air chambers; “closed cell foam” means that the foam comprises discrete closed pores. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. Polyurethane substrates according to the present invention include aromatic, aliphatic and hybrid (hybrid examples are silicone polyether or polyester urethane and silicone carbonate urethane) polyester or polyether based thermoplastic urethane. By “plastic” is meant any of the common thermoplastic or thermosetting synthetic materials, including thermoplastic olefins (“TPO”) such as polyethylene and polypropylene and blends thereof, thermoplastic urethane, polycarbonate, sheet molding compound, reaction-injection molding compound, acrylonitrile-based materials, nylon, and the like. A particular plastic is TPO that comprises polypropylene and EPDM (ethylene propylene diene monomer).

The dried array of particles (unitary or core-shell) on a substrate is fixed in a matrix by coating the array of particles with an inorganic matrix composition, followed by curing of the matrix composition to yield an inorganic matrix. As disclosed in U.S. Pat. No. 6,894,086 (incorporated herein by reference), the particles that have self-aligned in the dried array are interpenetrated with the curable matrix composition. The curable matrix composition material may be coated onto the dried array of particles via dipping, spraying, brushing, roll coating, gravure coating, curtain coating, flow coating, slot-die coating, or ink-jet coating. By coating, it is meant that the curable matrix composition covers at least substantially the entirety of the array and fills the interstitial spaces between the particles.

### Matrix

The cured inorganic matrix composition includes polymerizable components, which at least, upon curing, are resistant to organic solvent. By resistant to organic solvent, it is meant that the fixed matrix is not swellable upon contact with an organic solvent to an extent that would substantially increase interparticle spacing of the ordered periodic array, i.e., does not substantially increase the dimension (d).

Suitable curable inorganic matrix compositions are inorganic sols, such as sols of an alkoxide of the general formula RₓM(OR′)_{z-x} where R is an organic radical, M is a metal such as silicon, aluminum, titanium, and/or zirconium, each R′ is independently an alkyl radical, z is the valence of M, and x is a number less than z and may be zero. Examples of suitable organic radicals include, but are not limited to, alkyl, vinyl, methoxyalkyl, phenyl, γ-glycidoxy propyl and γ-methacryloxy propyl. Particularly suitable are compositions comprising siloxanes formed from at least partially hydrolyzing an organoalkoxysilane, such as one within the formula above. In one embodiment, the inorganic sol is an alkoxysilane such as methyltrimethoxy-silane. Such alkoxysilane sol may be cured in a condensation reaction, which is generally accomplished in the presence of an appropriate catalyst, such as a Lewis acid catalyst. The curing of the sol yields an inorganic sol-gel that is substantially resistant to organic solvents.

The matrix material may include a blend of inorganic matrix composition and an organic polymer. When present, the organic polymer may be an acrylic polymer, a polystyrene, a polyurethane, an alkyd polymer, a polyester, a siloxane-containing polymer, a polysulfide, an epoxy-containing polymer, or a polymer derived from an epoxy-containing polymer. In a blend of inorganic matrix material and organic polymer, the organic polymer may be included in an amount that is sufficiently low so as to not render the matrix material subject to swelling upon contact with an organic solvent.

In one embodiment of the invention, the radiation diffractive material includes the particles. A difference in refractive index between the matrix and the particles (such as by at least 0.01) causes the material to diffract radiation according to Bragg's law.

Alternatively, in another embodiment, after fixing the particles in place within the matrix, the particles are removed. This creates voids in the matrix, whereby a difference in refractive index is achieved between the matrix and the contents of the voids. The voids may contain air from the ambient environment, or they may be at least partially filled with a filler composition, as described below. The filler composition may be removable from the voids or remain therein.

The particles may be removed from the radiation diffractive material by various methods, including by dissolving the particles in a solvent and washing out the dissolved particles or by heating the material to volatilize the particles. For example, polystyrene particles may be dissolved in toluene, followed by heating to remove the toluene to leave air in the resulting voids. Generally, polymeric particles may be heated to over about 500° C. to volatilize the polymer. The voids created upon removal of the particles may be back-filled with a filler composition, such as a colorant (e.g. a photochromic composition and/or a pigmented composition), by soaking the radiation diffractive material in the filler composition. By including a colored filler composition in the voids, the radiation diffractive material may diffract radiation and exhibit a color (produced by the filler composition), thus providing for at least two color effects using a single composite structure.

In another embodiment, the filler composition is a removable material, such as water or organic solvent. Upon application of the removable filler to radiation diffractive material having an array of voids, the removable filler enters the voids. The refractive index of the removable filler differs from the refractive index of air. Accordingly, the effective refractive index (n) of Bragg's law changes. A change in the effective refractive index (n) shifts the wavelength of diffraction (λ). This shift in the wavelength of diffraction by the radiation diffraction material from an initial wavelength to a shifted wavelength may be used to indicate the presence of the removable filler composition. Upon removal of the filler composition (such as by drying), the wavelength of diffraction will revert to substantially the initial wavelength. In this manner, the radiation diffraction material may function as a sensor for the removable filler composition.

Alternatively, the radiation diffraction material may be used to test the authenticity of an item, e.g. as a security device. As a security device, the radiation diffraction material may be used to authenticate an article such as a document or device or to identify the source of a manufactured product. A document, such as a security card, that bears the radiation diffractive material of the present invention would be considered to be authentic if the material responds to an activator. A “security card” includes documents or devices that authenticate the identity of the bearer thereof or permit access to a facility, such as in the form of a badge. The security card may identify the bearer of the card (e.g., a photo-identification card or a passport) or may function as a document or device that indicates that the bearer thereof is to be permitted access to a secure facility.

For example, a security card having the radiation diffractive material on the card will exhibit a shift in the wavelength of diffracted radiation upon application of an appropriate activator, e.g. water. A counterfeit security card would fail to exhibit that wavelength shift when the activator is applied thereto. Likewise, consumers of an item (such as a pharmaceutical product) provided in packaging bearing radiation diffractive material of the present invention can test the packaging for its authenticity by applying the appropriate activator thereto. Packaging which does not respond to the activator would be considered to be counterfeit, while packaging that responds to the activator would be considered to be authentic. Other consumer goods may include the radiation diffractive material of the present invention, such as on the housing of a manufactured product (e.g. electronic devices) or on the surface of an article of clothing (e.g. shoes). The authenticity of the consumer goods may be tested by applying an activator thereto or activation of the radiation diffraction material may be a novelty feature of the article. “Article” includes any product, including but not limited to those discussed herein, to which the present invention can be applied.

The radiation diffractive material of the present invention is non-gelatinous and substantially solid. By non-gelatinous, it is meant that the radiation diffractive material does not contain a fluidizing material, such as water, and is not a hydrogel, nor produced from a hydrogel. In certain embodiments, the radiation diffractive material of the present invention substantially only includes the particles and the matrix with some possible residual solvent and, thus, is substantially solid. The volumetric ratio of the particles to the matrix in the radiation diffractive material is typically about 25:75 to about 80:20.

The radiation diffractive material may be applied to an article in various ways. In one embodiment, the radiation diffractive material is produced on a substrate and is then removed from the substrate and comminuted into particulate form, such as in the form of flakes. The comminuted radiation diffractive material may be incorporated as an additive in a coating composition for applying to an article. It may be beneficial to minimize the haze in a coating composition containing the comminuted radiation diffractive material. Reduced haze may be achieved by reducing the difference in refractive index between the matrix and particles of the radiation diffractive material. However, a reduction in the refractive index difference generally reduces the intensity of refracted radiation. Therefore, when minimal haze is desired and the refractive index difference is reduced, intensity may be maintained by increasing the thickness of the radiation diffractive material, i.e. by increasing the quantity of layers of particles in the array, as compared to material in which the refractive indices of the matrix and particles are more distinct from each other.

In one embodiment, the coating composition comprises a “hard coat”, such as an alkoxide of the general formula RₓM(OR′)_{z-x} described above. The alkoxide can be further mixed and/or reacted with other compounds and/or polymers known in the art. Particularly suitable are compositions comprising siloxanes formed from at least partially hydrolyzing an organoalkoxysilane, such as one within the formula above. Examples of suitable alkoxide-containing compounds and methods for making them are described in U.S. Pat. Nos. 6,355,189; 6,264,859; 6,469,119; 6,180,248; 5,916,686; 5,401,579; 4,799,963; 5,344,712; 4,731,264; 4,753,827; 4,754,012; 4,814,017; 5,115,023; 5,035,745; 5,231,156; 5,199,979; and 6,106,605, which are incorporated by reference herein.

In certain embodiments, the alkoxide comprises a combination of a glycidoxy[(C₁-C₃)alkyl]tri(C₁-C₄)alkoxysilane monomer and a tetra(C₁-C₆)alkoxysilane monomer. Glycidoxy[(C₁-C₃)alkyl]tri(C₁-C₄)alkoxysilane monomers suitable for use in the coating compositions of the present invention include glycidoxymethyltriethoxysilane, α-glycidoxyethyltrimethoxysilane, α-glycidoxyethyltriethoxysilane, β-glycidoxyethyltrimethoxysilane, α-glycidoxyethyltriethoxysilane, α-glycidoxy-propyltrimethoxysilane, α-glycidoxypropyltriethoxysilane, β-glycidoxypropyltrimethoxysilane, β-glycidoxypropyl-triethoxysilane, γ-glycidoxypropyltrimethoxysilane, hydrolysates thereof, and/or mixtures of such silane monomers.

Suitable tetra(C₁-C₆)alkoxysilanes that may be used in combination with the glycidoxy[(C₁-C₃)alkyl]tri(C₁-C₄)alkoxysilane in the coating compositions of the present invention include, for example, materials such as tetramethoxysilane, tetraethoxysilane, tetrapropoxysilane, tetrabutoxysilane, tetrapentyloxysilane, tetrahexyloxysilane and mixtures thereof.

In certain embodiments, the glycidoxy[(C₁-C₃)alkyl]tri(C₁-C₄)alkoxysilane and tetra(C₁-C₆)alkoxysilane monomers used in the coating compositions of the present invention are present in a weight ratio of glycidoxy [(C₁-C₃)alkyl]tri(C₁-C₄)alkoxysilane to tetra(C₁-C₆)alkoxysilane of from 0.5:1 to 100:1, such as 0.75:1 to 50:1 and, in some cases, from 1:1 to 5:1.

In certain embodiments, the alkoxide is at least partially hydrolyzed before it is combined with other components of the coating composition, such as the polymer-enclosed color-imparting particles. Such a hydrolysis reaction is described in U.S. Pat. No. 6,355,189 at col. 3, lines 7 to 28, the cited portion of which being incorporated by reference herein.

In certain embodiments, water is provided in an amount necessary for the hydrolysis of the hydrolyzable alkoxide(s). For example, in certain embodiments, water is present in an amount of at least 1.5 moles of water per mole of hydrolyzable alkoxide. In certain embodiments, atmospheric moisture, if sufficient, can be adequate.

In certain embodiments, a catalyst is providing to catalyze the hydrolysis and condensation reaction. In certain embodiments, the catalyst is an acidic material and/or a material, different from the acidic material, which generates an acid upon exposure to actinic radiation. In certain embodiments, the acidic material is chosen from an organic acid, inorganic acid or mixture thereof. Non-limiting examples of such materials include acetic, formic, glutaric, maleic, nitric, hydrochloric, phosphoric, hydrofluoric, sulfuric acid or mixtures thereof.

Any material that generates an acid on exposure to actinic radiation can be used as a hydrolysis and condensation catalyst in the coating compositions of the present invention, such as a Lewis acid and/or a Bronsted acid. Non-limiting examples of acid generating compounds include onium salts and iodosyl salts, aromatic diazonium salts, metallocenium salts, o-nitrobenzaldehyde, the polyoxymethylene polymers described in U.S. Pat. No. 3,991,033, the o-nitrocarbinol esters described in U.S. Pat. No. 3,849,137, the o-nitrophenyl acetals, their polyesters and end-capped derivatives described in U.S. Pat. No. 4,086,210, sulphonate esters or aromatic alcohols containing a carbonyl group in a position alpha or beta to the sulphonate ester group, N-sulphonyloxy derivatives of an aromatic amide or imide, aromatic oxime sulphonates, quinone diazides, and resins containing benzoin groups in the chain, such as those described in U.S. Pat. No. 4,368,253. Examples of these radiation activated acid catalysts are also disclosed in U.S. Pat. No. 5,451,345.

In certain embodiments, the acid generating compound is a cationic photoinitiator, such as an onium salt. Non-limiting examples of such materials include diaryliodonium salts and triarylsulfonium salts, which are commerically available as SarCat® CD-1012 and CD-1011 from Sartomer Company. Other suitable onium salts are described in U.S. Pat. No. 5,639,802, column 8, line 59 to column 10, line 46. Examples of such onium salts include 4,4′-dimethyldiphenyliodonium tetrafluoroborate, phenyl-4-octyloxyphenyl phenyliodonium hexafluoroantimonate, dodecyldiphenyl iodonium hexafluoroantimonate, [4-[(2-tetradecanol)oxy]phenyl]phenyl iodonium hexafluoroantimonate and mixtures thereof.

The amount of catalyst used in the coating compositions of the present invention can vary widely and depend on the particular materials used. Only the amount required to catalyze and/or initiate the hydrolysis and condensation reaction is required, e.g., a catalyzing amount. In certain embodiments, the acidic material and/or acid generating material can be used in an amount from 0.01 to 5 percent by weight, based on the total weight of the composition.

Alternatively, the radiation diffractive material may be applied directly to an article, whereby the substrate is a surface of an article, such as the packaging and/or the housing of an article of manufacture. By way of example, articles of manufacture may include consumer goods (including pharmaceutical products or food items) with the substrate being the packaging for the goods. More particularly, by “packaging”, it is meant a material in which an article is received. The composition of the packaging material is not limited and may include paper (or any other pulp-based materials), microporous sheets (as described above), fabric (woven and non-woven), leather (material or synthetic), glass, polymeric material, including flexible materials (such as in film form) or rigid materials. The packaging may be removed by the user of the article prior to use, or the packaging may remain in place. Non-limiting examples of packaging include paperboard or cardboard boxes, paper inserts visible through a plastic housing, plastic containers, and wrappers (metallic or plastic). Articles housed in the packaging of the present invention may include pharmaceutical products, personal care products, food items or other products for which authenticity is an indication of the source, safety, efficacy and/or quality thereof. Luxury items, such as designer products, may also be housed in the packaging of the present invention to authenticate their source and as a deterrent to counterfeiting.

In addition, the radiation diffractive material may be produced in the form of a film or sheet, which is then applied to an article such as via an adhesive or the like.

Alternatively, the article itself may serve as a substrate by applying the array of particles directly to the housing of the article such as the housing of electronic devices or directly to goods such as athletic equipment, accessories, optical lenses, optical frames, clothing, including shoes and the like.

The radiation diffractive material may further be at least partially covered with a coating composition in a multi-layered structure. In one embodiment, the radiation diffractive material is coated with the above-described “hard coat” coating composition. In another embodiment, the radiation diffractive material is coated with an anti-reflective coating, such as in a multi-layered antireflective stack. The anti-reflective coating may be formed of a dielectric material; e.g., metal oxides, such as Zn₂SnO₄, In₂SO₄, SnO₂, TiO₂, In₂O₃, ZnO, Si₃N₄ and/or Bi₂O₃ deposited by sputtering.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while reference is made herein, including the claims, to “an” ordered periodic array, “a” matrix, “an” activator, and the like, more than one can be used. Also, as used herein, the term “polymer” is meant to refer to prepolymers, oligomers and both homopolymers and copolymers; the prefix “poly” refers to two or more.

These exemplary uses of radiation diffractive material are not meant to be limiting. In addition, the following examples are merely illustrative of the present invention and are not intended to be limiting.

### EXAMPLES

### Example 1

### Sol-Gel Coating Composition

Deionized water (66.00 grams) and 30.00 grams of methanol were mixed in a clean reaction vessel. An increased temperature was observed as the result of the exothermal mixing process. The contents were cooled with a water bath to 20-25° C. In a separate container, 96.00 grams of methyltrimethoxysilane, 9.60 grams of glycidoxypropyltrimethoxysilane, 4.80 grams of glacial acetic acid, 1.88 grams of Uvinul® 400 (BASF Corporation), and 4.17 grams of 2-hydroxy-4-(3-triethoxysilylpropoxy)diphenylketone were blended together. This mixture was rapidly added to the reaction vessel under stirring. The water bath was maintained at a maximum reaction temperature of 35-50° C. The maximum temperature was reached 1-2 minutes after the addition. After one half hour, the water bath was removed, and the contents of the reaction vessel were stirred for 16-22 hours. A third charge of 30.00 grams of 2-propanol, 15.00 grams of diacetone alcohol, 0.24 grams of BYK®-300 (BYK-Chemie USA Inc.) and 0.12 grams of sodium acetate tri-hydrate was pre-mixed in a separate container and added into the reaction vessel. The reaction mixture was stirred for additional 4-5 hours. Finally, 0.48 grams of 25% tetramethylammonium hydroxide solution in methanol and 36.00 grams of ethyl acetate were mixed in a beaker. This solution was added into the reaction vessel. The reaction mixture was kept stirred for additional 24 hours at room temperature. The coating solution was filtered and stored refrigerated.

### Example 2

### Core-Shell Particles

A dispersion of polystyrene-divinylbenzene core/styrene-methyl methacrylate-ethylene glycol dimethacrylate-divinylbenzene shell particles in water was prepared via the following procedure.

Sodium bicarbonate from Aldrich Chemical Company, Inc. (3 g) was mixed with 4090 g deionized water and added to a 12-liter reaction kettle equipped with a thermocouple, heating mantle, stirrer, reflux condenser and nitrogen inlet. The mixture was sparged with nitrogen for 43 minutes with stirring and then blanketed with nitrogen. Aerosol MA80-I (19.7 g) from Cytec Industries, Inc., and 8.0 g Brij 35 (polyoxyethylene(23) lauryl ether) from the Aldrich Chemical Company, Inc., 2.5 g sodium styrene sulfonate (SSS) from Aldrich Chemical Company, Inc in 144 g deionized water were added to the mixture with stirring. The mixture was heated to approximately 50° C. using a heating mantle. Styrene monomer (720 g) and divinyl benzene (20 g), available from Aldrich Chemical Company, Inc., was added to reaction kettle with stirring. The mixture was heated to 60° C. Sodium persulfate from the Aldrich Chemical Company, Inc. (12.0 g in 144 g deionized water) was added to the mixture with stirring. Under agitation, the temperature was held at approximately 60° C. for 2.5 hours. A mixture of water (300 g), Brij 35 (1 g), divinyl benzene (100 g), styrene (200 g) and SSS (1 g) was added to reaction mixture with stirring. The temperature of the mixture was maintained at 60° C. for approximately 1 hour. A mixture of styrene (140 g), methyl methacrylate (210 g), ethylene glycol dimethacrylate (35 g), and SSS (4.5 g), all available from Aldrich Chemical Company, Inc., was added to the reaction mixture with stirring. The temperature of the mixture was maintained at 60° C. for approximately an additional 3.0 hours. The resulting polymer dispersion was filtered through a one-micron filter bag.

The polymer dispersion was ultrafiltered using a 4-inch ultrafiltration housing with a 2.41-inch polyvinylidine fluoride membrane, both from PTI Advanced Filtration, Inc. Oxnard, Calif., and pumped using a peristaltic pump at a flow rate of approximately 170 ml per second. Deionized water (2985 g) was added to the dispersion after 3000 g of ultrafiltrate had been removed. This exchange was repeated several times until 11,349 g of ultrafiltrate had been replaced with 11,348 g deionized water. Additional ultrafiltrate was then removed until the solids content of the mixture was 44.8 percent by weight. The material was applied via slot-die coater from Frontier Industrial Technology, Inc., Towanda, Pa. to a 2 mil thick polyethylene terephthalate (PET) substrate and dried at 180° F. for 40 seconds to a dry thickness of approximately 10 microns. The resulting material diffracted light at 454 nm measured with a Cary 500 spectrophotometer from Varian, Inc.

### Example 3

### Core/Shell Particles with Sol-Gel Matrix

A CCA film of the core/shell particles coated with a sol-gel matrix was prepared as follows. The sol-gel coating composition prepared in Example 1 was applied to the material produced in Example 2 using a drawdown bar. The sample was then dried and baked at 110° C. for 1 hr. The diffraction of the resulting film was then measured using an Ocean Optics 2000 spectrophotometer.

### Comparative Example 4

### Acrylate Coating

An ultraviolet radiation curable organic composition was prepared by adding Irgacure 2100 (0.1 g) from Ciba Specialty Chemicals Corp, Tarrytown, N.Y. with stirring to a mixture of propoxylated 2-neopentyl glycol diacrylate (SR9003, 8 g) and di-trimetholypropane tetraacrylate (SR 355, 2.0 g) from Sartomer Company, Inc., Exton, Pa.

### Comparative Example 5

### Core/Shell Particles with Acrylate Maxtrix

A CCA film of the core/shell particles coated with an acrylate matrix was prepared as follows. The acrylic coating composition prepared in Comparative Example 4 was deposited onto the material from Example 2 using a drawdown bar. A piece of 2 mil thick PET film was then placed upon the deposited material from Comparative Example 4 so that the material was entirely covered. A roller was used on the top side of the PET substrate to spread out and force the UV curable coating from Example 1 into the interstitial spaces of the material from Comparative Example 4. The sample was then ultraviolet radiation cured using a 100 W mercury lamp. The two layers of PET were then separated. The diffraction of the resulting film was then measured using an Ocean Optics 2000 spectrophotometer.

### Example 6

### Solvent Resistance

The CCA films prepared in Example 3 and Comparative Example 5 were immersed in solvents for 24 hours and then taken out to measure the change of diffraction wavelength immediately using an Ocean Optics 2000 spectrophotometer. The samples were then dried at room temperature for 24 hours and the diffraction was measured again.

The results are shown in Table 1. A shift (increase) in the wavelength of diffraction indicates that the interparticle spacing of the CCA increased, due to solvent swelling of the matrix and/or particles.

No shift in the wavelength of diffraction was exhibited in the radiation diffractive material of Example 3 (sol-gel matrix) when contacted with most solvents. More aggressive solvents (solvents I-K) are believed to have swollen the particles, not the matrix, resulting in the wavelength shift.

In comparison, all of solvents A-K caused the radiation diffractive material of Comparative Example 5 (acrylate matrix) to swell, thereby shifting the wavelength of diffraction.

TABLE 1
Comparison of sol-gel CCA film and acrylate CCA film

| | |
|---|---|
| Ex. 3 | Comp. Ex. 5 |
| Sol-gel film | Acrylate film |
| diffraction | diffraction |
| (nm) | (nm) |

| | | | | |
|---|---|---|---|---|
| Solvent | wet | dried | wet | dried |

| | | |
|---|---|---|
| None | 475 | 480 |

| | | | | | |
|---|---|---|---|---|---|
| A | Dowanol PM¹ acetate | 475 | 475 | 558 | 504 |
| B | Butyl Carbitol² | 475 | 475 | 520 | 511 |
| C | Xylene | 475 | 475 | 590 | 511 |
| D | Butanol | 475 | 475 | 499 | 486 |
| E | Isopropanol | 477 | 476 | 520 | 508 |
| F | Dowanol PM³ | 475 | 475 | 520 | 490 |
| G | 1-methyl-pyrrolidinone | 475 | 475 | 598 | 506 |
| H | butyl acetate | 475 | 475 | 562 | 509 |
| I | Acetone | 537 | 486 | 536 | 491 |
| J | methyl ethyl ketone | 537 | 490 | 550 | 481 |
| K | Toluene | 544 | 514 | 601 | 511 |

¹1-methoxy-2-acetoxypropane available from The Dow Chemical Company (Midland, MI)
²2-(2-Butoxyethoxy)ethanol, available from The Dow Chemical Company (Midland, MI)
³Propylene glycol methyl ether, available from The Dow Chemical Company (Midland, MI)

### Example 7

### Latex Particles

A dispersion of polystyrene (latex) particles in water was prepared via the following procedure. Sodium bicarbonate (2 g) was mixed with 2400 g deionized water and 150 g ethylene glycol available from Aldrich Chemical Company, Inc. and added to a 5-liter reaction kettle equipped with a thermocouple, heating mantle, stirrer, reflux condenser and nitrogen inlet. The mixture was sparged with nitrogen for 43 minutes with stirring and then blanketed with nitrogen. Aerosol MA80-I from Cytec Industries, Inc. (5.0 g) and 3.0 g Brij 35 (polyoxyethylene(23) lauryl ether), 1.4 g SSS in 144 g deionized water were added to the mixture with stirring. The mixture was heated to approximately 50° C. using a heating mantle. Styrene monomer (500 g) was added to the reaction kettle with stirring. The mixture was heated to 65° C. Sodium persulfate from (6 g in 100 g deionized water) was added to the mixture with stirring. Under agitation, the temperature was held at approximately 65° C. for 8 hours. A mixture of water (300 g), Brij 35 (2 g), styrene (185 g) and SSS (0.8 g) was added to reaction mixture with stirring. The temperature of the mixture was maintained at 65° C. for approximately 1 hour. A mixture of styrene (68 g), methyl methacrylate (102 g), ethylene glycol dimethacrylate (15 g), and SSS (0.8 g) was added to the reaction mixture with stirring. The temperature of the mixture was maintained at 65° C. for approximately additional 2 hours. The resulting polymer dispersion was filtered through a one-micron filter bag. The polymer dispersion was then ultrafiltered using a 4-inch ultrafiltration housing with a 2.41-inch polyvinylidine fluoride membrane and pumped using a peristaltic pump at a flow rate of approximately 170 ml per second. Deionized water (2985 g) was added to the dispersion after 3000 g of ultrafiltrate had been removed. This exchange was repeated several times until 11,349 g of ultrafiltrate had been replaced with 11,348 g deionized water. Additional ultrafiltrate was then removed until the solids content of the mixture was 44.8 percent by weight. The material was applied via slot-die coater from Frontier Industrial Technology, Inc. to a 2 mil thick PET substrate and dried at 180° F. for 40 seconds to a dry thickness of approximately 10 microns. The resulting material diffracted light at 886 nm measured with a Cary 500 spectrophotometer from Varian, Inc.

### Example 8

### Latex Particles with Sol-Gel Matrix

A CCA film of polystyrene particles coated with a sol-gel matrix was prepared as follows. The sol-gel coating composition prepared in Example 1 was applied to the material produced in Example 7 using a drawdown bar. The sample was then dried and baked at 110° C. for 1 hour. The diffraction of the resulting film was measured using a Cary 500 spectrophotometer.

### Example 9

### Array of Voids in Sol-Gel Matrix

The material of Example 8 was immersed in toluene for 24 hours to dissolve and remove the polystyrene particles and dried at room temperature to generate an array of voids dispersed in a silica gel matrix. The diffraction of the resulting film was measured with a Cary 500 spectrophotometer.

The results are listed in Table 2, including the amount of reflectance and calculated absorbance. By coating the array of latex particles with a sol-gel coating composition, the difference in refractive index between the particles and their surroundings (air in Ex. 7 and sol-gel matrix in Ex. 8), resulted in an increase in the wavelength of diffraction. However, the reflectance level was lowered in Ex. 8. Upon removal of the latex particles, the difference in refractive index between the resulting voids and the sol-gel matrix decreased, but the reflectance level significantly increased, providing high intensity of diffracted radiation.

TABLE 2
Comparison of diffraction of CCA films

| | | | Diffraction | Reflectance | Absorb- |
|---|---|---|---|---|---|
| Example | Array | Matrix | (nm) | (%) | ance |
| 7 | Latex | None (air) | 886 | 79 | 0.68 |
| 8 | Latex | Sol-gel | 959 | 17 | 0.082 |
| 9 | Voids (air) | Sol-gel | 789 | 91 | 1.024 |

While the preferred embodiments of the present invention are described above, obvious modifications and alterations of the present invention may be made without departing from the spirit and scope of the present invention. The scope of the present invention is defined in the appended claims and equivalents thereto.

The invention claimed is:

1. A radiation diffraction material comprising:
an ordered periodic array of diffracting regions received within a matrix, said matrix comprising an inorganic sol-gel.

2. The radiation diffraction material of claim 1, wherein said inorganic sol-gel comprises a silica sol.

3. The radiation diffraction material of claim 1, wherein said matrix is resistant to organic solvent.

4. The radiation diffraction material of claim 3, wherein said matrix further comprises an organic polymer.

5. The radiation diffraction material of claim 1, wherein said diffracting regions comprise particles.

6. The radiation diffraction material of claim 5, wherein said particles comprise a polymeric material comprising polystyrene, polyurethane, acrylic polymer, alkyd polymer, polyester, siloxane-containing polymer, polysulfide, epoxy-containing polymer and a polymer derived from and/or epoxy-containing polymer.

7. The radiation diffracting material of claim 1, wherein said diffracting regions comprise voids in said matrix.

8. The radiation diffracting material of claim 7, wherein said voids are configured to receive a composition therein.

9. The radiation diffracting material of claim 1, wherein said material is in particulate form.

10. A coating composition comprising a binder and the radiation diffraction material of claim 1.

11. The coating composition of claim 10 wherein the binder is a sol-gel coating composition.

12. A method of producing a radiation diffractive material comprising;
providing an ordered periodic array of particles;
coating the array of particles with an inorganic sol; and
polymerizing the sol to yield a sol-gel.

13. The method of claim 12, wherein the inorganic sol comprises a silica sol.

14. The method of claim 13, wherein the silica sol comprises an organosilane.

15. The method of claim 13, wherein the particles comprise a polymer selected from the group consisting of polystyrene, polyurethane, acrylic polymer, alkyd polymer, polyester, siloxane-containing polymer, polysulfide, epoxy-containing polymer and a polymer derived from an epoxy-containing polymer.

16. The method of claim 12, further comprising a step of removing the particles from the polymerized sol-gel to create an ordered periodic array of voids in the polymerized sol-gel.

17. The method of claim 16, wherein the step of removing the particles comprises dissolving the particles in a solvent.

18. The method of claim 16, wherein the step of removing the particles comprises volatilizing the particles.

19. The method of claim 16, further comprising placing a composition into the voids.

20. The method of claim 19, wherein the composition comprises a colorant.

21. A packaging for receiving an article, the packaging bearing a radiation diffraction material, said radiation diffraction material comprising an ordered periodic array of diffracting regions received within a matrix, said matrix comprising an inorganic sol-gel.

22. The packaging of claim 21, wherein said packaging comprises a material selected from the group consisting of paper, microporous sheet, fabric, leather, polymeric material, metal and glass.

23. The packaging of claim 21, wherein said packaging is configured to be removed prior to use of said article.

24. The packaging of claim 21, wherein said radiation diffraction material comprises an indicia of authenticity of the article.

25. A packaged article comprising the packaging of claim 21.

26. A security device comprising a security article bearing the radiation diffraction material of claim 1.
